(19) United States
(12) Patent Application Publication
(10) Pub. No.: US 2012/0078569 A1
(43) Pub. Date: Mar. 29, 2012

(54) METHOD AND CONTROL UNIT FOR CLASSIFYING A COLLISION OF A VEHICLE

(76) Inventors: Alfons Doerr, Stuttgart (DE); Marcus Hiemer, Kehlen (DE)

(21) Appl. No.: 13/202,280

(22) PCT Filed: Dec. 21, 2009
(86) PCT No.: PCT/EP2009/067621

§ 371 Date: Sep. 26, 2011

(30) Foreign Application Priority Data
Feb. 20, 2009 (DE) 10 2009 001 027.0

(51) Int. Cl. G06F 19/00; G01P 15/00

(52) U.S. Cl. 702/141

(57) ABSTRACT

A method for detecting a collision of a vehicle is described, including a step of receiving a linear signal and a rotation signal via an interface, the linear signal containing information about a linear motion, and the rotation signal containing information about a rotational motion of the vehicle. The method also includes a step of supplying an evaluation signal based on the linear signal and the rotation signal, the evaluation signal containing information about the collision.

### FIELD OF THE INVENTION

The present invention relates to a method, control unit and computer program for classifying a collision of a vehicle.

### BACKGROUND INFORMATION

In conventional algorithms for triggering passenger protection devices of a vehicle, the linear motion of the vehicle is taken into account. This motion is often approximated by the motion of a point mass.

The signals of linear acceleration sensors may be used for the collision classification (collision=crash). Two characteristic lines may be used, one of which suppresses misuse and the other generates the decision to trigger the passenger protection devices. The signal energy is evaluated, and the passenger protection devices are triggered only if the signal energy is present continuously. Here, only linear motions are taken into account.

In the past, rotatory collisions in an early phase of the collision have been underestimated in the severity of the collision. Offset collisions, for example, the ODB (offset deformable barrier) type of crash in EuroNCAP, may often be detected only by complex signal processing.

German Patent Application No. DE 101 49 112 A1 describes a method for forming a triggering decision for a restraint system, which in particular handles situations in which the vehicle slides laterally after a spin and then reaches a surface having a high coefficient of friction. The triggering decision is determined as a function of the driving dynamics data, using a float angle in conjunction with a transverse vehicle velocity and a tilting motion of the vehicle as the driving dynamics data. The triggering decision is formed by a threshold value comparison.

### SUMMARY

Against this background, an example method for classifying a collision of a vehicle, as well as an example control unit which uses this method, and finally an appropriate computer program product is provided. Advantageous embodiments are derived from the description below.

In accordance with the present invention, the actual vehicle motion is not described solely by a linear motion. Instead, collisions actually occurring in the field are characterized in that both linear and rotational motions occur in the collision. Therefore, according to the present invention, the rotatory kinetic energy and its persistence are also taken into account in addition to the linear kinetic energy. Collisions involving rotation may therefore be taken into account appropriately.

In accordance with the present invention, rotatory signal energy in both actual collisions and indoor test crash collisions are taken into account. Passenger protection devices may be triggered according to the present invention if there is either a persistent rotational power or a persistent linear power. Conventional double characteristic lines and algorithms may be used for this purpose.

By combining linear and rotatory motion, it is possible to promptly recognize previously “underestimated” collisions. This may result in an improved determination of the severity of a collision and the time of triggering. The severity of rotatory collisions may therefore be detected advantageously in an early phase of the collision. Offset collisions may also be detected promptly by simple signal processing. According to an example embodiment of the present invention, it is also possible to take into account the total mechanical power, i.e., the total power or total energy converted during the early collision phase. The persistence of the rotational energy and/or rotational power which occurs in the collision may be taken into account by using a double characteristic line. The robustness of the triggering decision may be increased in this way. The approach according to the present invention also allows a synergistic use and thus permits savings in terms of sensor systems in both active and passive safety systems. For example, sensors of the ESP system may be used as crash sensors for the airbag system, and thus new airbag functionalities may be provided.

A method for classifying a collision of a vehicle according to an example embodiment of the present invention includes the following steps: receiving a linear signal over an interface, the linear signal containing information about a linear motion of the vehicle; receiving a rotation signal over an interface, the rotation signal containing information about a rotational motion of the vehicle; and providing an evaluation signal based on the linear signal and the rotation signal, the evaluation signal containing information about the collision.

The linear signal and the rotation signal may represent signals supplied by sensors. The sensors may be acceleration sensors situated in the vehicle. The linear motion may be a motion of the vehicle in the direction of travel. The rotational motion may be a rotary motion such as a yawing motion. The evaluation signal may be supplied at an interface. The information about the collision may be suitable for indicating the type of collision. The information about the collision may also be suitable for specifically indicating collisions requiring triggering of a passenger protection means. The information about the collision may thus be used to make a triggering decision for a passenger protection means.

The evaluation signal may be determined by linking a linear evaluation signal and a rotatory evaluation signal, the linear evaluation signal having information about the collision based on the linear signal, and the rotatory evaluation signal having information about the collision based on the rotation signal. The linkage of the linear component and the rotatory component allows an improved detection and classification of the collision.

According to one embodiment, a triggering collision (fire) in response to which a restraint device is to be triggered, as well as a non-triggering collision (misuse), in response to which the restraint device is not to be triggered, may be detected based on the linear signal, and the linear evaluation signal may be formed, to have a first value for a triggering collision which is detected and a second value for a non-triggering collision which is detected. By differentiating between triggering collisions and non-triggering collisions, faulty triggerings of passenger protection devices are preventable.

To do so, the linear signal may contain information about a linear acceleration of the vehicle, and the following equation may be evaluated for detecting the triggering collision and the non-triggering collision:

$${a}_{x} = \frac{{P}_{Lin}}{m} \cdot \frac{1}{dv}$$

where
aₓ: linear acceleration of the vehicle
P_{Lin}: linear kinetic power
m: mass of the vehicle
dv: linear velocity change of the vehicle.

Furthermore, based on the rotation signal, a triggering collision as well as a non-triggering collision may be detected, and the rotatory evaluation signal may be formed to have a first value when a triggering collision is detected and a second value when a non-triggering collision is detected. Faulty triggerings may also be prevented in this way.

To do so, the rotation signal may contain information about a rotatory velocity of the vehicle, and the following equation may be analyzed for detecting the triggering collision and the non-triggering collision:

$$Ψ = \frac{{P}_{Rot}}{J} \cdot \frac{1}{Ψ}$$

where
Ψ: rotational acceleration of the vehicle
P_{Rot}: rotational kinetic energy
m: mass of the vehicle
Ψ: rotatory velocity of the vehicle.

According to another exemplary embodiment, the information about the collision may be determined from the linear signal and the rotation signal using a multidimensional classifier. Thus, for evaluating the information contained in the linear signal and in the rotation signal, a neural network, a hidden Markov model, or a support vector machine may be used.

The linear signal may represent information about a linear kinetic energy of the vehicle and the rotation signal may represent information about a rotatory kinetic energy of the vehicle, and the information about the collision may be determined based on the linear kinetic energy and the rotatory kinetic energy. Thus, the total energy acting on the vehicle in the collision may be taken into account.

For example, the information about the collision may be determined based on a linear acceleration, a linear velocity, a rotatory acceleration, and a rotatory velocity of the vehicle. The required values may be supplied by conventional sensors or determined by simple signal processing of sensor signals.

An object of the present invention may also be achieved rapidly and efficiently through the embodiment variant of the present invention in the form of a control unit. A control unit in the present case may be understood to be an electric device, which processes sensor signals and outputs control signals as a function thereof. The control unit may have an interface, which may be implemented in hardware and/or software. In the case of hardware, the interfaces may be part of a so-called system ASIC, for example, which includes a wide variety of functions of the control unit. However, it is also possible for the interfaces to be separate integrated circuits or at least to partially include discrete components. In the case of software, the interfaces may be software modules, which are present on a microcontroller in addition to other software modules, for example.

Also advantageous is a computer program product having program code stored on a machine-readable carrier, such as a semiconductor memory, a hard drive memory, or an optical memory and used to implement the example method according to one of the specific embodiments described above when the program is executed on a control unit.

### BRIEF DESCRIPTION OF THE DRAWINGS

The present invention is explained in greater detail below on the basis of the figures.

FIG. 1 shows a block diagram of a system according to one exemplary embodiment of the present invention.

FIG. 2 shows a block diagram of a system according to another exemplary embodiment of the present invention.

FIG. 3 shows a diagram of rotatory signal energy in a collision.

FIG. 4 shows a diagram of linear signal energy in a collision.

### DETAILED DESCRIPTION OF EXAMPLE EMBODIMENTS

The same or similar elements may be provided with the same or similar reference numerals in the following figures. Furthermore, the figures and the description herein contain numerous features in combination. It will be clear to those skilled in the art that these features may also be considered individually or may be combined into other combinations not described explicitly here.

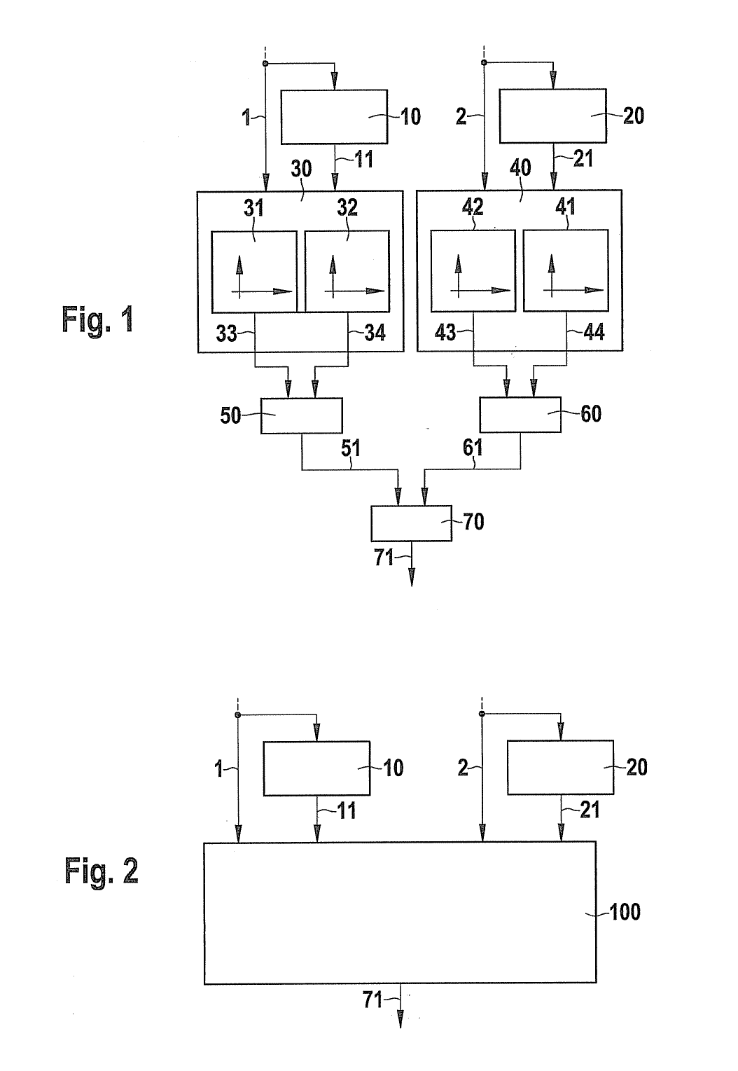

FIG. 1 shows a block diagram of a system for classifying a collision of a vehicle according to an exemplary embodiment of the present invention. A possible design and a possible function of the system are shown in particular. This system is designed to execute the example method according to the present invention for classifying a collision of a vehicle.

In the method for classification according to the present invention, a linear signal 1 may be received via an interface. Linear signal 1 may contain information about a linear motion of the vehicle. For example, linear signal 1 may represent a linear acceleration aₓ of the vehicle. Furthermore, a rotation signal 2 may be received via the interface, rotation signal 2 possibly containing information about a rotational motion of the vehicle. For example, rotation signal 2 may represent an angular velocity of the vehicle. Based on linear signal 1 and rotation signal 2, information about the collision may be ascertained and supplied in the form of an evaluation signal 71 at an interface. Based on the information about the collision, evaluation signal 71 is suitable for triggering a passenger protection device.

The system may have a device 10, for example, in the form of an integrator, and a device 20, for example, in the form of a differentiator. Furthermore, the system may have a device 30 for evaluating a linear kinetic energy, which in turn has a device 31 for detecting a non-triggering collision (misuse) and a device 32 for detecting a triggering collision (fire/no fire). Accordingly, a device 40 for evaluating a rotatory kinetic energy may have a device 41 for detecting a triggering collision (fire/no fire) and a device 42 for detecting a non-triggering collision (misuse). A differentiation between the non-triggering collision and the triggering collision may be made with the aid of devices 31, 32 and devices 41, 42.

Linear signal 1 may be received by device 10 and device 30 for evaluating a linear kinetic energy. Device 10 is designed to supply a signal 11 to device 30 for evaluating a linear kinetic energy in response to the linear signal. Signal 11 may represent a change in velocity dv of the vehicle. Device 31 for detecting a non-triggering collision is designed to supply a signal 33 to a linkage device 50 based on linear signal 1 and signal 11. Device 32 for detecting a triggering collision is designed to supply a signal 34 to linkage device 50 based on linear signal 1 and signal 11. Signals 33, 34 may be designed to indicate whether a triggering collision or a non-triggering collision has been detected. Linkage device 50 may be an AND gate. Linkage device 50 may be designed to supply a linear evaluation signal 51 to a linkage device 70, which may be an OR gate.

Accordingly, rotation signal 2 may be received by device 20 and device 40 for evaluating a rotatory kinetic energy. Device 20 is designed to supply a signal 21 to device 40 for evaluating a rotatory kinetic energy in response to the rotation signal. Signal 21 may represent a yawing acceleration of the vehicle. Device 41 for detecting a triggering collision is designed to supply, based on rotation signal 2 and signal 21, a signal 44 to a linkage device 60, which may be an AND gate. Device 42 for detecting a non-triggering collision is designed to supply a signal 43 to linkage device 60 based on rotation signal 2 and signal 21. Signals 43, 44 may be designed to indicate whether a triggering collision or a non-triggering collision has been detected. Linkage device 60 may be an AND gate. Linkage device 60 may be designed to supply a rotatory evaluation signal 61 to linkage device 70. Linkage device 70 is designed to supply evaluation signal 73 based on linear evaluation signal 51 and rotatory evaluation signal 61.

According to the exemplary embodiment shown in FIG. 1, data 1 of a linear acceleration sensor, for example, acceleration x in integrator 10 may be integrated chronologically into a linear signal path and may supply signal 11, for example, velocity reduction dv. Instead of an integrator, a window integrator or a filter approximating the window integrator may also be implemented in block 10. Variables 1, 11 are processed in block 30, in which the linear kinetic energy, or power, is evaluated. Linear kinetic energy E_{Lin} is calculated as follows:

$${E}_{Lin} = \frac{1}{2} m \cdot {dv}^{2} ⇒ {P}_{Lin} = \frac{d}{d t} {E}_{lin} = m \cdot dv \cdot {a}_{x} \\ ⇒ {a}_{x} = \frac{{P}_{Lin}}{m} \cdot \frac{1}{dv}$$

This equation shows that there is a physical relationship between signal 1 (ax in the example) and signal 11 (dv in the example). This relationship is taken into account in a misuse block 31 and in a fire/no fire block 32 in the system shown in FIG. 1.

If it is assumed that the linear power of an external action on the vehicle exceeds a certain threshold value of crash power P_{Lin} only in a significant vehicle collision, then the physical relationship of the equation yields a hyperbolic threshold value function aₓ(dv, P_{Lin}), which clearly separates the regions between a crash event and a misuse event in an ax-dv diagram. Thus, in the case of full braking, momentum transfer dv to the vehicle is great, but force ax acting on the sensor element is small. In the case of a hammer blow, the force acting on the sensor element is great but the momentum transfer to the vehicle is small. However, if force ax acting on the sensor element during a vehicle collision increases disproportionately in comparison with momentum transfer dv, then either a high collision velocity or a hard collision barrier must be assumed, requiring activation of a restraint device. If deceleration ax increases relatively little in the vehicle collision in comparison with the momentum transfer, then a low collision velocity and a soft barrier may be assumed. In this case, the activation of the restraint device is not necessary.

In block 31, the possibility of the signal energy being input through misuse, i.e., is large and usually short, is eliminated. For a linear collision, a misuse may be a hammer blow or striking a curb, which could cause a brief longitudinal acceleration in sensor signal 1. Since such a signal 1 induced by misuse should not be sufficient to trigger passenger protection devices, the persistence of the input signal energy is also investigated. In block 32, the persistence of the linear signal energy is taken into account and evaluated. Both blocks 31, 32 contain two-dimensional characteristic lines, which are checked for whether they are exceeded. If the characteristic line in block 31 is exceeded once or several times in succession in another characteristic of the present invention, then the status of signal line 33 changes from “0” to “1.” If the characteristic line in block 32 is exceeded once or several times in succession in another characteristic of the present invention, then the status of signal line 34 changes from “0” to “1.” Signals 33, 34 are both subjected to a logic AND operation in block 50. In this way, signal 51 contains exactly one logic “1” if it is not a misuse and if the signal energy is persistent, i.e., there is a collision in which the restraint means are to be triggered.

Similarly, data 2 of a yaw rate sensor in a rotatory signal path, for example, the yaw rate, may be derived in differentiator 20 with respect to time and may supply derived signal 21, for example, the yaw acceleration. Differentiator 20 may then be implemented via a differential operation between two filtered or unfiltered successive or offset signal values of signal 2. Another advantageous implementation of differentiator 20 may be a recursive least squares estimator. Signals 2 and 21 are processed in block 40, in which the rotatory kinetic energy, or power, is evaluated. Rotatory kinetic energy E_{Rot} is calculated as follows:

$${E}_{Rot} = \frac{1}{2} J \cdot {Ψ}^{2} ⇒ {P}_{Rot} = \frac{d}{d t} {E}_{Rot} = J \cdot Ψ \cdot \ddot{Ψ} \\ ⇒ Ψ = \frac{\ddot{{P}_{Rot}}}{J} \cdot \frac{1}{Ψ}$$

This equation shows that there is a direct physical relationship between signal 2, in this example the yaw rate, and signal 21, for example, the yaw acceleration. This relationship is taken into account in the system shown in FIG. 1 in misuse block 42 and fire/no fire block 41. In block 42, the possibility that the signal energy is input due to a misuse, i.e., is large and usually short, is ruled out. For a rotatory collision, this might be a soccer ball, for example, which is impelled laterally against the fender, or a lateral collision with a moped. Such collisions may cause a brief yaw acceleration in the sensor signal. Since such a signal should not be sufficient to trigger passenger protection devices, the persistence of the signal energy input is still investigated. Therefore, in block 41 the persistence of the rotatory signal energy is taken into account and evaluated. Both blocks 41, 42 contain two-dimensional characteristic lines, which are checked for whether they are exceeded. If the characteristic line in block 42 is exceeded once or several times in succession in another characteristic of the present invention, then the status of signal line 43 changes from “0” to “1.” If the characteristic line in block 41 is exceeded once or several times in succession in another characteristic of the present invention, then the status of signal line 44 changes from “0” to “1.” Both signals 43, 44 are subjected to a logic AND operation in block 60. In this way, signal 61 then contains exactly a logic 1 when it is not a misuse and when the signal energy is persistent; it is thus a crash in which the restraint devices are to be triggered.

The linear and rotatory paths may be fused in linkage device 70. If there is either a rotatory collision or a linear collision, the triggering decision is triggered. The fusion of the two paths in the logic OR operation in block 70 fulfills this logic. The output of the system is a fire flag 71, which is able to trigger the restraint devices.

FIG. 2 shows a block diagram of an example system according to the present invention for classifying a collision of a vehicle according to another exemplary embodiment of the present invention. Instead of the design illustrated in FIG. 1, a multidimensional classifier 100 is used here. Multidimensional classifier 100 is designed to generate evaluation signal 71 on the basis of linear signal 1, signal 11, rotation signal 2 and signal 21. Linear signal 1 may in turn include linear acceleration aₓ; signal 11 may include velocity change dv; rotation signal 2 may include angular velocity Ψ; and signal 21 may include rotatory acceleration Ψ of the vehicle. According to this exemplary embodiment, classifier 100 may be designed as a four-dimensional classifier. Neural networks are an advantageous characteristic of multidimensional classifier 100. The support vector machine is another advantageous characteristic. The method based on the support vector machine is characterized in that it has been shown to be implementable with minimal microprocessor resources and also manages with very small collision sets.

This is an advantage compared to neural networks in particular.

The fusion of the linear path and the rotatory path according to the present invention takes into account the fact that real world crash scenarios cannot be described exclusively by a point mass driving frontally against a wall or barrier. A collision crash is described comprehensively only by a combination of rotatory and linear motions.

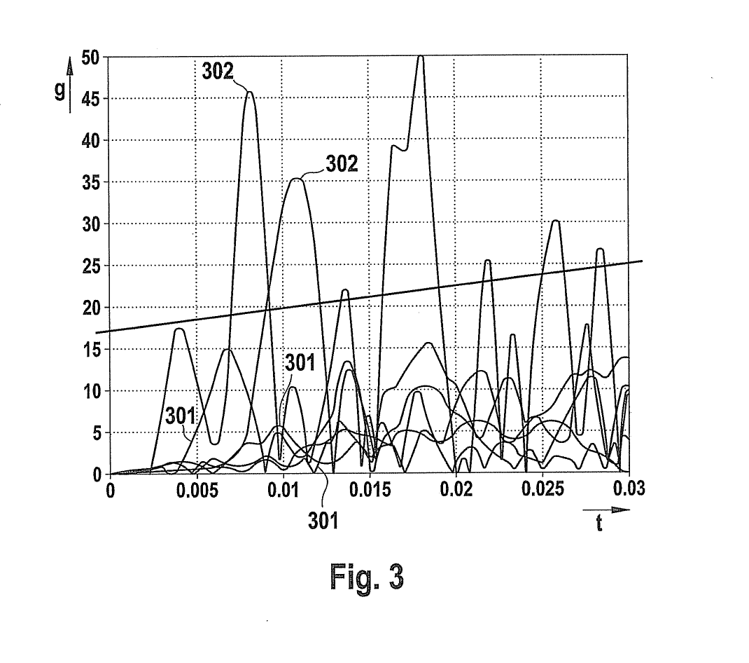

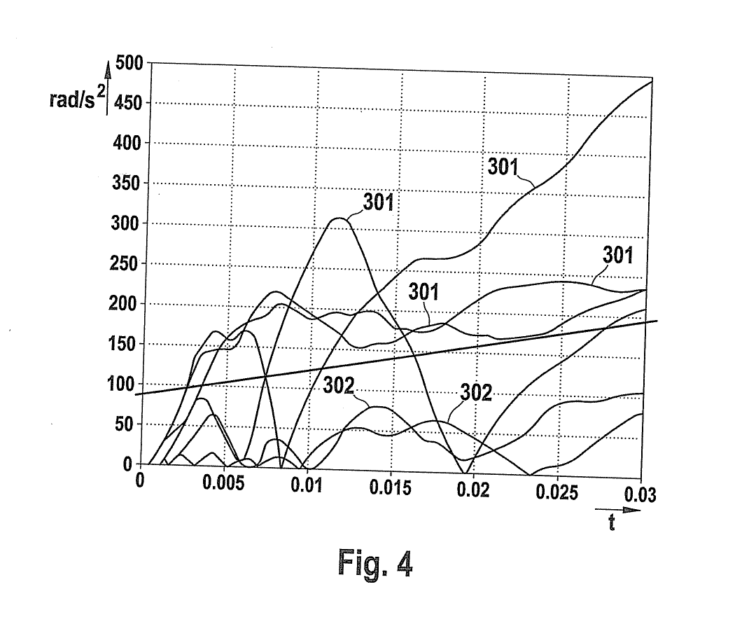

FIGS. 3 and 4 show a comparison of the signal energies in rotatory and non-rotatory collisions. The greater the amplitudes of the signals, the higher is the signal energy component.

FIG. 3 shows a graphic representation of a low pass-filtered longitudinal acceleration of a vehicle over time. Time t is plotted on the abscissa and longitudinal acceleration g is plotted on the ordinate. Various characteristic lines 301, 302 represent various vehicle collisions. FIG. 3 shows that characteristic lines 301 representing rotatory collisions have hardly any longitudinal acceleration signal. Thus, the signal energy is low. On the other hand, characteristic lines 302 representing non-rotatory collisions have a strong longitudinal acceleration signal.

FIG. 4 shows a graphic representation of an RLS-filtered yaw acceleration of a vehicle over time. Time t is plotted on the abscissa and longitudinal acceleration rad/s² is plotted on the ordinate. FIG. 4 shows that characteristic lines 301 of rotatory collisions have a much stronger yaw acceleration signal in comparison with FIG. 3. The signal energy is thus high. Accordingly, characteristic lines 302 of non-rotatory collisions have a low yaw acceleration signal. The combination of the linear signal energy shown in FIG. 3 with the rotatory signal energy shown in FIG. 4 gives an indication of the total signal energy. Therefore, it is possible to better recognize the collision severity of severe rotatory collisions, for example, EuroNCAP or angular collisions due to the combination according to the present invention of linear acceleration signals 301, 302, shown in FIG. 3, and rotational motion signals 301, 302, shown in FIG. 4.

The solid lines in FIGS. 3 and 4 are, for example, threshold value curves, which may vary as a function of a crash-specific feature. The threshold value curve in FIG. 3, for example, marks the maximum longitudinal acceleration to be expected in a typical offset collision in standard indoor crash tests. However, the threshold value curve in FIG. 4 marks the minimum rotational acceleration to be expected in the aforementioned offset collisions. The threshold value curves may each also vary further, depending on the severity of the crash.

The approach according to the example embodiment of the present invention may be used profitably in an airbag project, for example, which obtains data from an airbag control unit or from a DCU. Such systems have rotation signals of a sufficiently high scan frequency in the algorithm.

The exemplary embodiments described here have been selected only as examples and may be combined with one another.

1-11. (canceled)

12. A method for classifying a collision of a vehicle, comprising:
receiving a linear signal via an interface, the linear signal containing information about a linear motion of the vehicle;
receiving a rotation signal via an interface, the rotation signal containing information about a rotational motion of the vehicle; and
supplying an evaluation signal based on the linear signal and the rotation signal, the evaluation signal having information about the collision.

13. The method as recited in claim 12, wherein the evaluation signal is determined by a linkage of a linear evaluation signal and a rotatory evaluation signal, the linear evaluation signal having information about the collision based on the linear signal, and the rotatory evaluation signal having information about the collision based on the rotation signal.

14. The method as recited in claim 13, wherein, based on the linear signal, a triggering collision, in response to which a restraint device is to be triggered, as well as a non-triggering collision, in response to which the restraint device is not to be triggered, may be detected, and wherein the linear evaluation signal is formed to have a first value when a triggering collision is detected and to have a second value when a non-triggering collision is detected.

15. The method as recited in claim 14, wherein the linear signal contains information about a linear acceleration of the vehicle, and the following equation is evaluated for detecting the triggering collision and the non-triggering collision:
$${a}_{x} = \frac{{P}_{Lin}}{m} \cdot \frac{1}{dv}$$
where
aₓ: linear acceleration of the vehicle
P_{Lin}: linear kinetic power
m: mass of the vehicle
dv: linear velocity change of the vehicle.

16. The method as recited in one of claim 13, wherein, based on the rotation signal, a triggering collision as well as a non-triggering collision may be detected, and wherein the rotatory evaluation signal is formed to have a first value when a triggering collision is detected and to have a second value when a non-triggering collision is detected.

17. The method as recited in one of claim 14, wherein the rotation signal contains information about a rotatory velocity of the vehicle, and the following equation is evaluated for detecting the triggering collision and the non-triggering collision:
$$Ψ = \frac{\ddot{{P}_{Rot}}}{J} \cdot \frac{1}{Ψ}$$
where
Ψ: rotary acceleration of the vehicle
P_{Rot}: rotatory kinetic power
m: mass of the vehicle
Ψ: rotatory velocity of the vehicle.

18. The method as recited in claim 12, wherein the information about the collision is determined from the linear signal and the rotation signal by using a multidimensional classifier.

19. The method as recited in claim 12, wherein the linear signal represents information about a linear kinetic energy of the vehicle, and the rotation signal represents information about a rotatory kinetic energy of the vehicle, and the information about the collision is determined based on the linear kinetic energy and the rotatory kinetic energy.

20. The method as recited in claim 12, wherein the information about the collision is determined based on a linear acceleration, a linear velocity, a rotatory acceleration and a rotatory velocity of the vehicle.

21. A control unit configured to classify a collision of a vehicle, the control unit configured to perform the steps of:
receiving a linear signal via an interface, the linear signal containing information about a linear motion of the vehicle;
receiving a rotation signal via an interface, the rotation signal containing information about a rotational motion of the vehicle; and
supplying an evaluation signal based on the linear signal and the rotation signal, the evaluation signal having information about the collision.

22. A machine-readable carrier storing program code, the program code, when executed by a control unit, causing the control unit to perform the steps of:
receiving a linear signal via an interface, the linear signal containing information about a linear motion of the vehicle;
receiving a rotation signal via an interface, the rotation signal containing information about a rotational motion of the vehicle; and
supplying an evaluation signal based on the linear signal and the rotation signal, the evaluation signal having information about the collision.
